(19) United States
(12) Patent Application Publication
(10) Pub. No.: US 2024/0375796 A1
(43) Pub. Date: Nov. 14, 2024

(54) SPACEHEAD STRUCTURE OF SPACE FACILITY

(71) Applicant: Nippon Telegraph and Telephone Corporation, Tokyo (JP)

(72) Inventor: Yoshiharu HIROSHIMA, Musashino-shi, Tokyo (JP)

(21) Appl. No.: 18/688,648

(22) PCT Filed: Sep. 14, 2021
(86) PCT No.: PCT/JP2021/033712

§ 371 Date: Mar. 1, 2024

(51) Int. Cl. B64G 1/60; B64G 1/56

(52) U.S. Cl. CPC B64G 1/60; B64G 1/56

(57) ABSTRACT

Provided is a bulkhead structure for shielding a space facility (100) installed in outer space from an external space, the bulkhead structure including: a pressurized wall (11) that sealingly covers a periphery of the space facility (100) such that an internal space (14) of the space facility (100) has a predetermined air pressure; and a protective wall (12) that is provided on a side outward from the periphery of the pressurized wall (11) at an interval from the pressurized wall (11) and protects an outer periphery of the pressurized wall (11). At least a part of an outer wall space (15) formed between the pressurized wall (11) and the protective wall (12) is filled with water.

### TECHNICAL FIELD

The present invention relates to a bulkhead structure for a space facility.

### BACKGROUND ART

When high-energy particles (mainly protons) contained in space radiation collide with atomic nuclei of oxygen and nitrogen in the Earth's atmosphere, neutron rays are generated and fall on the ground. Non Patent Literature 1 discloses that neutron rays falling on the ground cause malfunction of an electronic device placed on the ground or burnout of a circuit element.

On the other hand, in a space facility (for example, a manned space facility) installed in outer space, space radiation collides with an outer wall covering the periphery of the space facility to generate neutron rays, and the neutron rays enter the space facility to generate a phenomenon similar to the above phenomenon. In space facilities, unlike on the ground, attenuation due to passing through atmospheric layers does not occur. Therefore, the influence of the space radiation on the electronic device is greater than that on the ground.

Non Patent Literature 2 discloses that the influence of space radiation on an electronic device used in a space facility is reduced by taking measures such as using a component having higher resistance to space radiation than an electronic device used on the ground or duplicating an electronic device system.

Non Patent Literature 3 discloses using a wet towel installed in a space facility as a method for reducing space radiation in the space facility.

### CITATION LIST

### Non Patent Literature

Non Patent Literature 1: Shoji, Nishida “Pawadebaisu no uchu hoshasen hakai tairyo ni kansuru kenkyu (in Japanese) (Study on space radiation damage tolerance of power devices)”, Institute of Electrical Engineers of Japan Technical Development Report, 2016
Non Patent Literature 2: Japan Aerospace Exploration Agency “Uchu tenyo kano buhin no uchu tekiyo handobukku (in Japanese) (Space application handbook for parts that can be diverted to space)”, JERG-2-023, established in May 2015 Non Patent Literature 3: Kodaira, “Uettotaoru o mochiita uchu taizaichu no uchu hoshasen hibaku no teigen-ho (in Japanese) (Reduction of space radiation exposure during stay in space using wet towel)”, Isotope News, August 2014

### SUMMARY OF INVENTION

### Technical Problem

However, in the method disclosed in Non Patent Literature 2, there arises a problem that the installation cost of the electronic device increases. In addition, although the method disclosed in Non Patent Literature 3 can reduce the space radiation to some extent, the effect thereof is small and does not lead to a fundamental solution.

The present invention has been made in view of the above circumstances, and an object of the present invention is to provide a bulkhead structure of a space facility capable of attenuating space radiation entering the space facility.

### Solution to Problem

A bulkhead structure for a space facility according to an aspect of the present invention is a bulkhead structure for shielding a space facility installed in outer space from an external space, the bulkhead structure including: a pressurized wall that sealingly covers a periphery of the space facility such that an internal space of the space facility has a predetermined air pressure; and a protective wall that is provided on a side outward from the periphery of the pressurized wall at an interval from the pressurized wall and protects an outer periphery of the pressurized wall, in which at least a part of an outer wall space formed between the pressurized wall and the protective wall is filled with water.

### Advantageous Effects of Invention

According to the present invention, it is possible to attenuate space radiation entering a space facility.

### BRIEF DESCRIPTION OF DRAWINGS

FIG. 1 is an explanatory diagram schematically illustrating a cross section of a space facility on which a bulkhead structure according to an embodiment is mounted.

FIG. 2A is an explanatory diagram showing a trajectory of protons when an outer wall space is evacuated and a protective wall is irradiated with protons of 100 [MeV].

FIG. 2B is an explanatory diagram showing a trajectory of protons when the outer wall space is filled with water and the protective wall is irradiated with protons of 100 [MeV].

FIG. 3A is a graph showing the energy of protons and neutrons that have passed through two aluminum alloy plates when the space between the two aluminum alloy plates is evacuated and irradiated with protons of 100 [MeV].

FIG. 3B is a graph showing the energy of protons and neutrons that have passed through two aluminum alloy plates when the space between the two aluminum alloy plates is filled with water and irradiated with protons of 100 [MeV].

FIG. 4A is a graph showing the energy of protons and neutrons that have passed through two aluminum alloy plates when the space between the two aluminum alloy plates is evacuated and irradiated with protons of 150 [MeV].

FIG. 4B is a graph showing the energy of protons and neutrons that have passed through two aluminum alloy plates when the space between the two aluminum alloy plates is filled with water and irradiated with protons of 150 [MeV].

FIG. 5A is a graph showing the energy of protons and neutrons that have passed through two aluminum alloy plates when the space between the two aluminum alloy plates is evacuated and irradiated with protons of 200 [MeV].

FIG. 5B is a graph showing the energy of protons and neutrons that have passed through two aluminum alloy plates when the space between the two aluminum alloy plates is filled with water and irradiated with protons of 200 [MeV].

FIG. 6 is a graph showing a proportion of protons passing through the outer wall space when the outer wall space is irradiated with protons having a uniform energy distribution of 1 to 200 [MeV].

FIG. 7 is an explanatory diagram illustrating a first example in which the outer wall space is filled with water.

FIG. 8 is an explanatory diagram illustrating a second example in which the outer wall space is filled with water.

FIG. 9 is an explanatory diagram illustrating a third example in which the outer wall space is filled with water.

### DESCRIPTION OF EMBODIMENTS

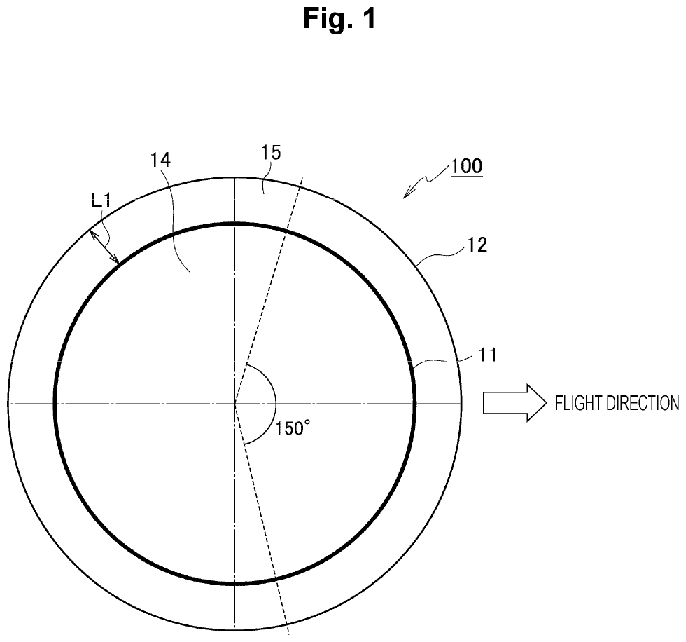

Embodiments will be described below with reference to the drawings. FIG. 1 is an explanatory diagram schematically illustrating a cross section of a space facility on which a bulkhead structure according to an embodiment is mounted.

A space facility 100 according to the present embodiment is a manned facility installed in outer space, such as an artificial satellite. As illustrated in FIG. 1, the space facility 100 is sealed off from the external space. The space facility 100 has a cylindrical shape. Therefore, in the cross-sectional view illustrated in FIG. 1, the space facility 100 has a circular shape. Note that the space facility 100 is not limited to a cylindrical shape, and may have another shape having a closed space.

As illustrated in FIG. 1, the space facility 100 is provided with a pressurized wall 11 having a ring shape in cross section. A space surrounded by the pressurized wall 11 of the space facility 100 is an internal space 14. The internal space 14 is a closed space surrounded by the pressurized wall 11. The pressurized wall 11 sealingly covers the periphery of the space facility 100 such that the internal space 14 of the space facility 100 has a predetermined air pressure.

On the outer periphery of the pressurized wall 11, a protective wall 12 is provided to prevent damage to the pressurized wall 11 due to debris such as dust and wreckage floating in outer space. The protective wall 12 is provided on the side outward from the periphery of the pressurized wall 11 at an interval L1 from the pressurized wall 11 and protects the outer periphery of the pressurized wall 11. An outer wall space 15 is formed between the pressurized wall 11 and the protective wall 12. That is, the periphery of the space facility 100 has a double structure of the pressurized wall 11 and the protective wall 12. The outer wall space 15 is a closed space surrounded by the pressurized wall 11 and the protective wall 12. In the present embodiment, the outer wall space 15 is used as a water storage tank to attenuate space radiation.

In manned space facilities, domestic water such as drinking water is used. For example, in a supply machine “Kounotori 6” that carries supplies to the International Space Station (ISS), 600 liters of drinking water is transported at a time, and thus there is about 1000 liters of water including the water that existed until then. In the present embodiment, this water is used to attenuate space radiation.

The pressurized wall 11 and the protective wall 12 are made of, for example, an aluminum alloy. The aluminum alloy is an alloy in which strength is increased by including copper (Cu), manganese (Mn), silicon (Si), magnesium (Mg), zinc (Zn), nickel (Ni), and the like in aluminum.

Note that, in the cross-sectional view illustrated in FIG. 1, the ratio between the internal space 14 and the outer wall space 15 does not represent the actual ratio of the space facility 100. In order to facilitate understanding, the thickness of the outer wall space 15 with respect to the internal space 14, that is, the interval L1 is exaggerated.

In the present embodiment, at least a part of the outer wall space 15 is filled with water, and entry of space radiation is suppressed by the filled water. The water filled into the outer wall space 15 is domestic water such as drinking water used in space facilities. That is, the outer wall space 15 has a function as a water storage tank that stores water to be used in the space facility 100.

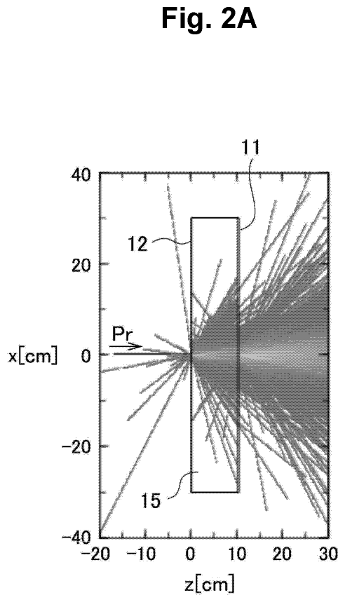

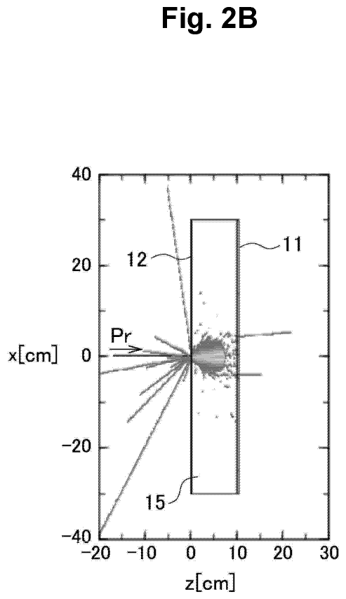

Next, attenuation of space radiation in a case where the outer wall space 15 is evacuated and in a case where the outer wall space is filled with water will be described. FIGS. 2A and 2B are explanatory diagrams showing trajectories of protons Pr when the protective wall 12 is irradiated with the protons Pr of 100 [MeV]; FIG. 2A shows a case where the outer wall space 15 is evacuated, and FIG. 2B shows a case where the outer wall space 15 is filled with water.

As shown in FIG. 2A, in a case where the outer wall space 15 is evacuated, the protons Pr emitted from the outside of the protective wall 12 are hardly attenuated in the outer wall space 15, and pass through the protective wall 12 and the pressurized wall 11 to enter the internal space.

On the other hand, as shown in FIG. 2B, in a case where the outer wall space 15 is filled with water, the protons Pr emitted from the outside of the protective wall 12 are attenuated in the layer of water filled into the outer wall space 15, and hardly enter the internal space.

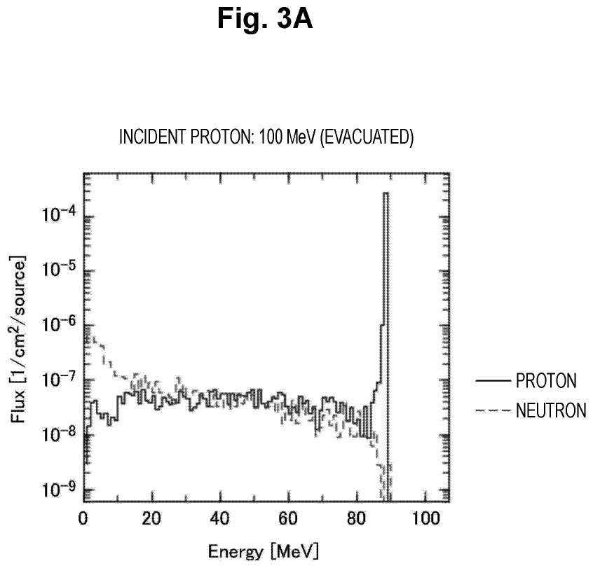

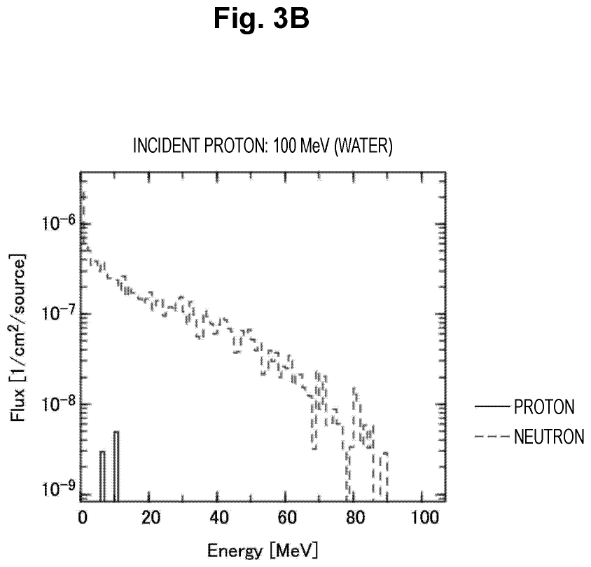

FIGS. 3A to 5B are graphs showing the energy of protons and neutrons that have passed through two aluminum alloy plates when a device in which the two aluminum alloy plates are arranged in parallel at an interval of 10 cm is prepared in order to simulate the outer wall space 15, in a case where a space between the two aluminum alloy plates is evacuated, and in a case where a space therebetween is filled with water. For example, the results can be obtained by conducting a simulation using a well-known particle transport simulator “PHITS”.

In FIGS. 3A to 5B, broken lines indicate the energy of neutrons, and solid lines indicate the energy of protons.

FIGS. 3A and 3B show the energy of protons and neutrons that have passed through two aluminum alloy plates when the energy of protons to be emitted is 100 [MeV], in a case where a space between the two aluminum alloy plates is evacuated, and in a case where a space therebetween is filled with water.

As shown in FIG. 3A, in a case where the space is evacuated, the maximum value of the energy of protons that have passed through the two aluminum alloy plates reaches 90 [MeV]. On the other hand, as shown in FIG. 3B, in a case where the space is filled with water, the maximum value of the energy of the protons that have passed through the two aluminum alloy plates is about 10 [MeV].

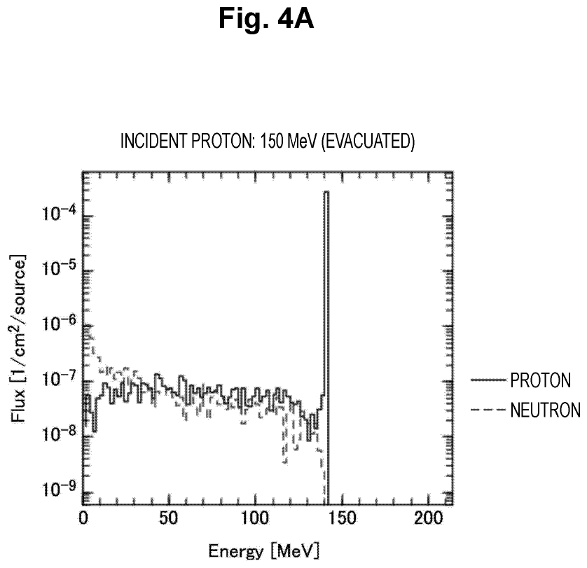

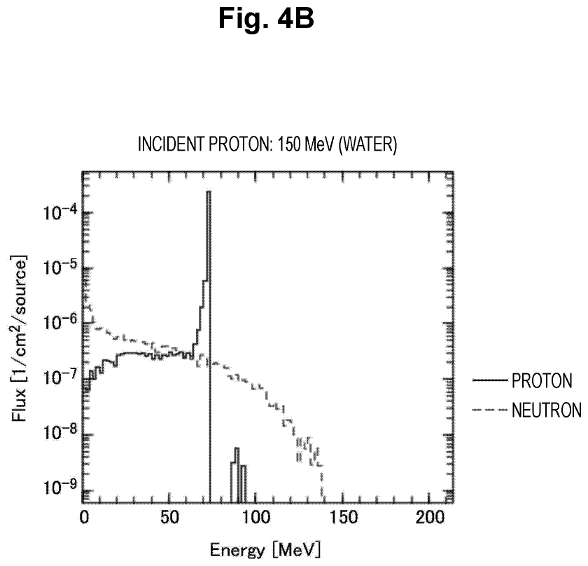

FIGS. 4A and 4B show the energy of protons and neutrons that have passed through two aluminum alloy plates when the energy of protons to be emitted is 150 [MeV], in a case where the space between the two aluminum alloy plates is evacuated, and in a case where the space is filled with water.

As shown in FIG. 4A, in a case where the space is evacuated, the maximum value of the energy of protons that have passed through the two aluminum alloy plates reaches 140 [MeV]. On the other hand, as shown in FIG. 4B, in a case where the space is filled with water, the maximum value of the energy of the protons that have passed through the two aluminum alloy plates is about 100 [MeV].

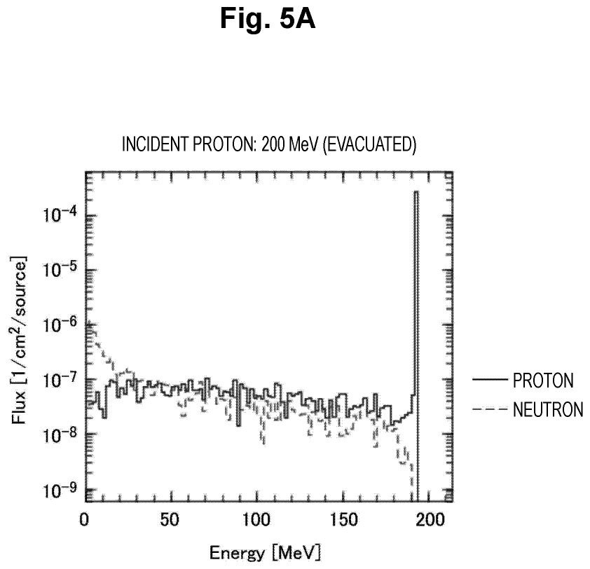

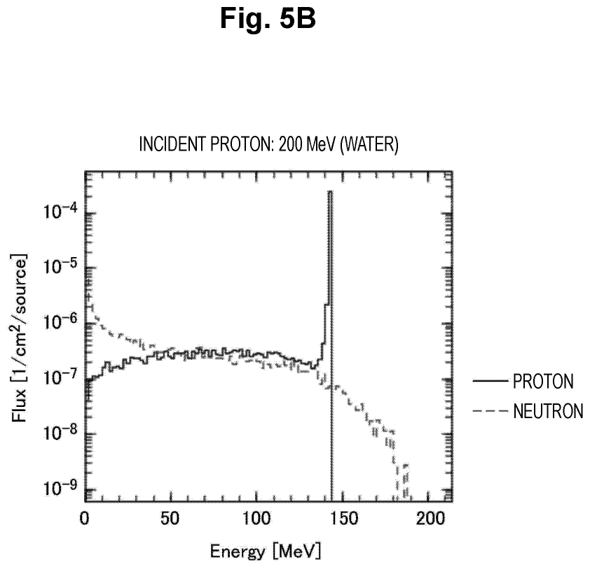

FIGS. 5A and 5B show the energy of protons and neutrons that have passed through two aluminum alloy plates when the energy of protons to be emitted is 200 [MeV], in a case where the space between the two aluminum alloy plates is evacuated, and in a case where the space is filled with water.

As shown in FIG. 5A, in a case where the space is evacuated, the maximum value of the energy of protons that have passed through the two aluminum alloy plates reaches 190 [MeV]. On the other hand, as shown in FIG. 5B, in a case where the space is filled with water, the maximum value of the energy of the protons that have passed through the two aluminum alloy plates is about 140 [MeV]. That is, it is understood that the energy of protons passing through the two aluminum alloy plates can be significantly reduced by filling the space between the two aluminum alloy plates with water.

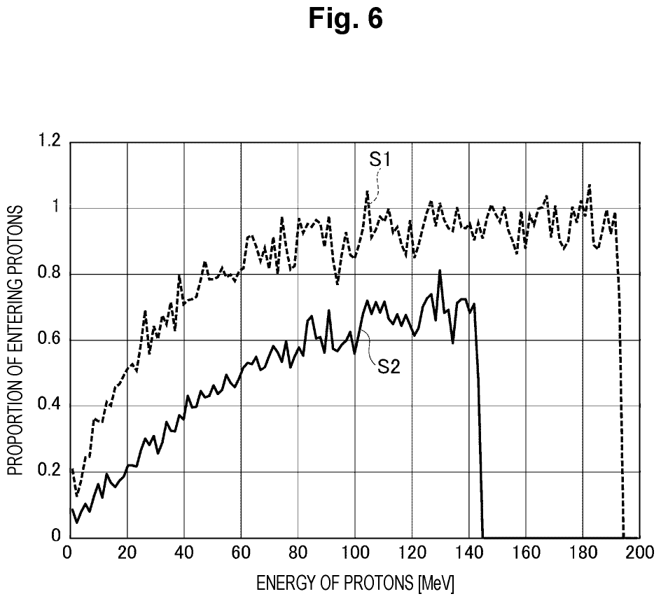

FIG. 6 is a graph showing the proportion of protons passing through two aluminum alloy plates when the two aluminum alloy plates are irradiated with protons having a uniform energy distribution of 1 to 200 [MeV]. A curve S1 illustrated in FIG. 6 indicates a case where the space between two aluminum alloy plates is evacuated, and a case where a curve S2 indicates a case where the space is filled with water.

As understood from FIG. 6, in a case where the space is evacuated (curve S1), the protons are hardly reduced at 100 [MeV] or more. That is, the “proportion of entering protons” shown on the vertical axis is approximately 1.0 (100%). On the other hand, in a case where the space is filled with water, it is understood that there are no protons of 140 [MeV] or more and the proportion of entering protons is 0.8 (80%) or less even when the energy is less than 140 [MeV]. That is, by filling the space (the outer wall space 15 illustrated in FIG. 1) between the two aluminum alloy plates surrounded by the two aluminum alloy plates (the pressurized wall 11 and the protective wall 12 illustrated in FIG. 1) with water, the number of protons passing through the outer wall space 15 and the energy of the protons are attenuated.

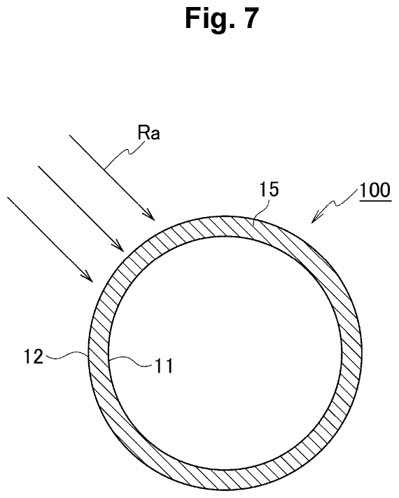

Next, examples in which the outer wall space 15 is filled with water will be described with reference to FIGS. 7, 8, and 9.

### First Example

FIG. 7 is an explanatory diagram illustrating a first example in which the outer wall space 15 is filled with water. In FIG. 7, hatched regions indicate regions filled with water. In the first example, the entire outer wall space 15 is filled with water as illustrated in FIG. 7. That is, by filling the entire periphery of the internal space 14 of the space facility 100 with water, entry of space radiation emitted from all directions of the external space can be suppressed.

### Second Example

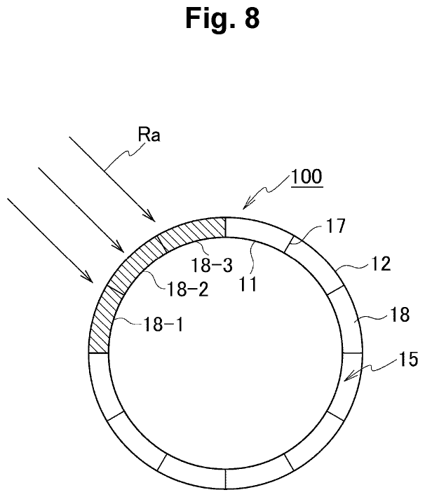

FIG. 8 is an explanatory diagram illustrating a second example in which the outer wall space 15 is filled with water. In the second example, as illustrated in FIG. 8, the outer wall space 15 is divided into a plurality of divided areas along the circumferential direction. Specifically, as illustrated in FIG. 8, a plurality of (12 in FIG. 8) partition plates 17 extending in the axial direction of a space facility having a cylindrical shape are installed, and the outer wall space 15 is divided into 12 divided areas 18 along the circumferential direction.

Among them, the divided areas 18 existing in the direction in which space radiation Ra is emitted are filled with water. In the example illustrated in FIG. 8, three consecutive divided areas 18-1, 18-2, and 18-3 are filled with water. That is, the outer wall space 15 is divided into a plurality of divided areas 18, and at least one of the divided areas 18 is filled with water. With such a configuration, even in a case where the amount of water to be stored is small with respect to the capacity of the outer wall space 15, the space radiation Ra with which the space facility 100 is irradiated can be efficiently shielded. That is, it is possible to attenuate the space radiation with a small amount of water by recognizing the direction in which the space radiation arrives in advance and filling the divided areas 18 facing this arrival direction with water. The number of the divided areas 18 to be filled with water is not limited to three, and may be two or less or four or more.

Furthermore, as illustrated in FIG. 1, the divided areas 18 to be filled with water may be set in a range having a predetermined angle around the direction in which the space facility 100 flies. For example, in a case where the predetermined angle is 150°, the divided areas 18 in a range of 150° around the flight direction of the space facility 100 may be filled with water. That is, the space facility 100 may have a cylindrical shape, and the outer wall space 15 having a cross section in the radial direction of the cylindrical shape within a range of a predetermined angle with respect to the traveling direction (flight direction) of the space facility 100 may be filled with water.

### Third Example

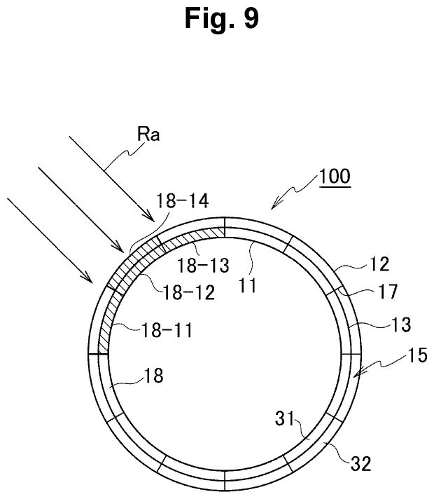

FIG. 9 is an explanatory diagram illustrating a third example in which the outer wall space 15 is filled with water. In the third example, as illustrated in FIG. 9, the outer wall space 15 is divided into two in the radial direction by providing an intermediate wall 13 between the pressurized wall 11 and the protective wall 12 in the outer wall space 15. That is, the intermediate wall 13 separates the pressurized wall 11 and the protective wall 12 from each other. A space between the pressurized wall 11 and the intermediate wall 13 is defined as a first space 31, and a space between the intermediate wall 13 and the protective wall 12 is defined as a second space 32.

Further, similarly to the second example described above, by installing the partition plate 17, the first space 31 and the second space 32 are divided into a plurality of divided areas 18 along the circumferential direction.

Among them, the divided areas 18 existing in the direction in which space radiation Ra is emitted are filled with water. In the example illustrated in FIG. 9, four divided areas 18-11, 18-12, 18-13, and 18-14 are filled with water. That is, the intermediate wall 13 that separates the pressurized wall 11 and the protective wall 12 from each other is further provided, the first space 31 divided by the pressurized wall 11 and the intermediate wall 13 and the second space 32 divided by the intermediate wall 13 and the protective wall 12 are each divided into the plurality of divided areas 18, and at least one divided area 18 of the divided areas of the first space 31 and the divided areas of the second space 32 is filled with water.

With such a configuration, it is possible to appropriately set a thick region and a thin region of the layer to be filled with water, and it is possible to fill the region irradiated with more space radiation Ra with water. Therefore, even in a case where the amount of water stored in the outer wall space 15 is small, the space radiation Ra with which the space facility 100 is irradiated can be efficiently shielded.

As described above, the bulkhead structure according to the present embodiment is a bulkhead structure for shielding the space facility 100 installed in outer space from an external space, the bulkhead structure includes: the pressurized wall 11 that sealingly covers a periphery of the space facility 100 such that the internal space 14 of the space facility 100 has a predetermined air pressure; and the protective wall 12 that is provided on a side outward from the periphery of the pressurized wall 11 at an interval from the pressurized wall 11 and protects an outer periphery of the pressurized wall 11, and at least a part of the outer wall space 15 formed between the pressurized wall 11 and the protective wall 12 is filled with water.

Therefore, the energy of space radiation entering the internal space 14 of the space facility 100 from the outside of the space facility 100 can be reduced, and malfunction occurring in electronic devices used in the internal space 14 and burnout of elements can be prevented.

In the present embodiment, the outer wall space 15 covered by the pressurized wall 11 and the protective wall 12 is divided into a plurality of divided areas 18, and at least one of the divided areas 18 is filled with water. Therefore, by specifying the direction in which the space radiation is emitted around the space facility 100 and filling the divided area 18 existing in this direction with water, the energy of the space radiation can be efficiently reduced even in a case where the amount of water to be filled is small and the entire outer wall space 15 cannot be filled with water.

In the present embodiment, as illustrated in FIG. 1, the space facility 100 has a cylindrical shape, and the outer wall space 15 having a cross section in the radial direction of the cylindrical shape within a range of a predetermined angle (for example,) 150° with respect to the traveling direction of the space facility 100 is filled with water. That is, by filling the divided areas 18 having a predetermined angle with respect to the traveling direction of the space facility 100 with water, it is possible to reduce radiation from a direction in which more space radiation is irradiated.

In the present embodiment, as illustrated in FIG. 9, the intermediate wall 13 that separates between the pressurized wall 11 and the protective wall 12 from each other is provided, the first space 31 between the pressurized wall 11 and the intermediate wall 13 and the second space 32 between the intermediate wall 13 and the protective wall 12 are each divided into the plurality of divided areas 18, and at least one of the divided areas 18 of the first space 31 and the divided areas 18 of the second space 32 is filled with water. Therefore, it is possible to change the thickness of filling water in the radial direction of the space facility 100 having a cylindrical shape, and it is possible to reduce the entry of space radiation.

In the present embodiment, the outer wall space 15 is a water storage tank that stores water to be used in the space facility 100. Therefore, domestic water as a necessary item in the space facility 100 can be used as water for shielding space radiation, and it is possible to reduce the cost incurred when using the space facility 100.

Note that the present invention is not limited to the above embodiment, and various modifications can be made within the scope of the gist of the present invention.

### REFERENCE SIGNS LIST

11 Pressurized wall
12 Protective wall
13 Intermediate wall
14 Internal space
15 Outer wall space
17 Partition plate
18 Divided area
31 First space
32 Second space
100 Space facility

1. A bulkhead structure for a space facility, the bulkhead structure shielding the space facility installed in outer space from an external space, the bulkhead structure comprising:
a pressurized wall that sealingly covers a periphery of the space facility such that an internal space of the space facility has a predetermined air pressure; and
a protective wall that is provided on a side outward from the periphery of the pressurized wall at an interval from the pressurized wall and protects an outer periphery of the pressurized wall,
wherein at least a part of an outer wall space formed between the pressurized wall and the protective wall is filled with water.

2. The bulkhead structure for a space facility according to claim 1,
wherein the outer wall space is divided into a plurality of divided areas, and at least one of the divided areas is filled with the water.

3. The bulkhead structure for a space facility according to claim 1, further comprising
an intermediate wall that separates the pressurized wall and the protective wall from each other,
wherein a first space between the pressurized wall and the intermediate wall and a second space between the intermediate wall and the protective wall are each divided into a plurality of divided areas, and at least one of the divided areas of the first space and the divided areas of the second space is filled with water.

4. The bulkhead structure for a space facility according to claim 1,
wherein the space facility has a cylindrical shape, and the outer wall space having a cross section in a radial direction of the cylindrical shape within a range of a predetermined angle with respect to a traveling direction of the space facility is filled with water.

5. The bulkhead structure for a space facility according to claim 1,
wherein the outer wall space is a water storage tank that stores water to be used in the space facility.
